(19) United States
(12) Patent Application Publication
(10) Pub. No.: US 2016/0130061 A1
(43) Pub. Date: May 12, 2016

(54) Propane bottle lock

(71) Applicant: Ethel Lennan, Redding, CA (US)

(72) Inventor: Ethel Lennan, Redding, CA (US)

(21) Appl. No.: 14/927,353

(22) Filed: Oct. 29, 2015

Related U.S. Application Data
(60) Provisional application No. 62/076,993, filed on Nov. 7, 2014.

(51) Int. Cl. B65D 71/50; E05B 67/38

(52) U.S. Cl. CPC B65D 71/50; E05B 67/383

(57) ABSTRACT

The invention is a device for propane bottles. The device comprises a base, two wings, and a cylinder. The cylinder fits over a mounting bracket for propane bottles. The wings receive the shackle of a padlock and allow the entire configuration to be secured.

### BACKGROUND

This invention relates to a device for securing unlocked propane bottles. Current devices for securing propane bottles are typically over-built and contain too many moving parts. This invention solves these problems because it has no moving parts. It also provides the benefits of being nearly indestructible, fire proof, low-cost, and quick to install.

### SUMMARY

The present invention is directed toward a device for securing propane bottles or bottles containing other pressurized fluids. The device is intended to be small enough to be hand-operated and portable. Basically, the device comprises a single piece of sheet metal that is cut and bent into a particular shape. The shape of the device allows the device to be fitted over a bracket that typically rests between two propane bottles. A padlock can then be fitted through two holes in the device and locked to secure the propane bottles.

These as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

FIG. 1 is a front isometric view of an example embodiment.

FIG. 2 is a top view of the example embodiment of FIG. 1.

FIG. 3 is a front view of the example embodiment of FIG. 1.

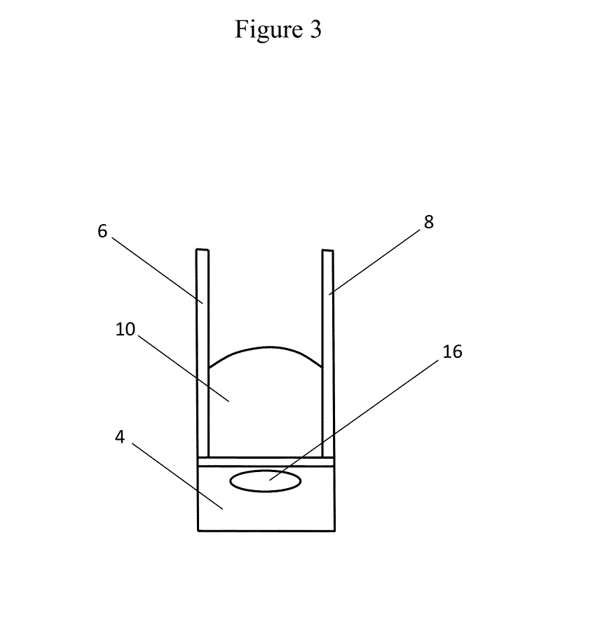

FIG. 4 is a side view of the example embodiment of FIG. 1.

### DETAILED DESCRIPTION

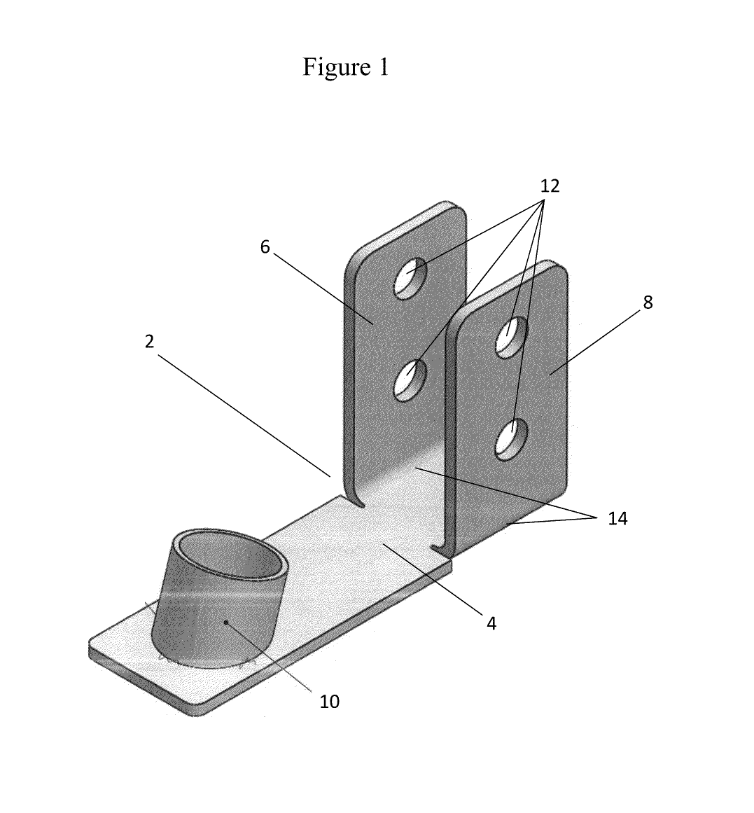

In the particular embodiment illustrated in FIG. 1, bottle lock 2 comprises base 4, first wing 6, second wing 8, and cylinder 10. Base 4, first wing 6, and second wing 8 are composed of one piece of cut and bent sheet metal. Cylinder 10 is composed of similar metal and is fixedly attached to base 4 by welding.

Wings 6 and 8 are formed by bending the cut sheet metal at bend points 14. The wings are bent at approximately right angles such that they are parallel or nearly parallel to each other. Holes 12 are cut in circular shapes of sufficient size to accommodate the shackle of a typical padlock. Holes 12 are spaced to accommodate the shackle of a typical padlock.

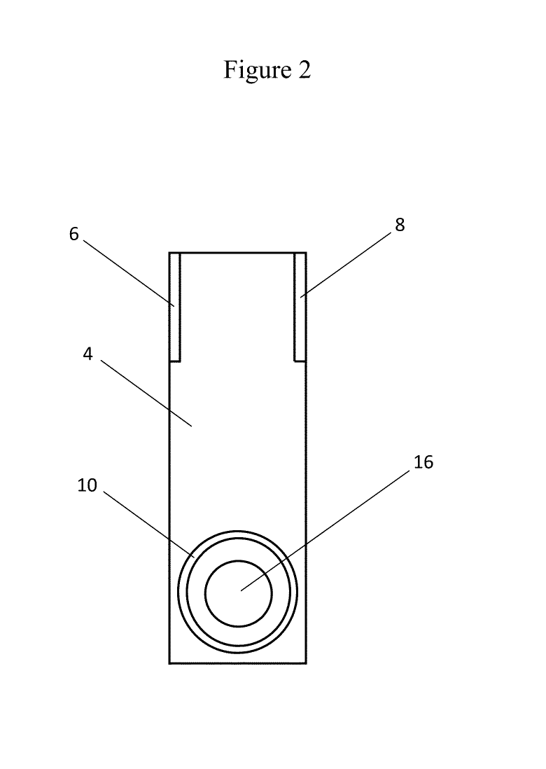

Cylinder 10 is sized such that it will fit loosely over a typical mounting bracket for dual propane bottles. As shown in FIG. 2, cylinder 10 is attached to base 4 such that it encompasses but does not intersect with hole 16.

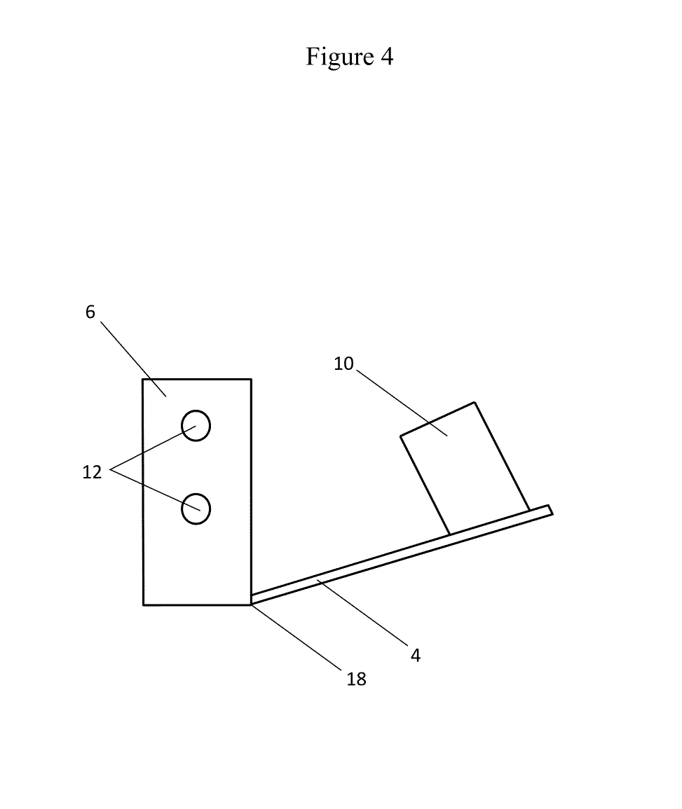

As shown in FIG. 4, base 4 can be optionally bent at bend point 18.

The bottle lock is operated by placing cylinder 10 over the mounting bracket of a dual propane bottle container. A padlock can then be inserted through all four of holes 12 and locked. The propane bottles are now secure.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims. Other embodiments may be utilized, and other changes may be made, without departing from the spirit or scope of the subject matter presented herein. It will be readily understood that the aspects of the present disclosure, as generally described herein and illustrated in the figures, can be arranged, substituted, combined, separated, and designed in a wide variety of different configurations, all of which are contemplated herein.

What is claimed is:

1. A device comprising:
a base;
a first wing and a second wing attached to said base, being substantially perpendicular to said base and substantially parallel to each other;
said first and second wings having at least one hole sufficiently sized to allow the shackle of a typical padlock to pass through;
a cylinder attached to said base;
said cylinder being substantially perpendicular to said base;
said cylinder being substantially hollow.

2. The device of claim 1 wherein said cylinder is attached to said base by means of welding.

3. The device of claim 1 wherein said base contains at least one hole that is smaller in diameter than said cylinder, and said cylinder is attached over said hole.
